(19) United States
(12) Patent Application Publication
(10) Pub. No.: US 2016/0038259 A1
(43) Pub. Date: Feb. 11, 2016

(54) DENTAL APPLIANCE FOR ADJUSTING THE POSITION OF THE LOWER JAW OF A PATIENT WITH RESPECT TO THE UPPER JAW THEREOF

(71) Applicant: Michel Valceschini, Les Monts-de-Corsier (CH)

(72) Inventor: Michel Valceschini, Les Monts-de-Corsier (CH)

(21) Appl. No.: 14/636,572

(22) Filed: Mar. 3, 2015

(30) Foreign Application Priority Data
Jan. 28, 2014 (EP) 14152944.6

(51) Int. Cl. A61C 7/36; A61C 7/08

(52) U.S. Cl. CPC A61C 7/36; A61C 7/08

(57) ABSTRACT

A dental appliance for adjusting the positioning of the lower jaw of a patient with respect to the upper jaw thereof, including an upper tray and a lower tray intended to fit the teeth of the upper and lower jaw, respectively, wherein the trays are connected to one another by means of a spring wire being substantially in the shape of a U, the spring wire arranged in an occlusal position between the trays without protruding into the vestibular regions of the mouth of the patient, wherein each end of the spring wire is mounted pivotably on a first of the lower and upper trays about an axis of pivoting arranged parallel to the occlusal plane of contact of the teeth of the lower and upper jaws, wherein the spring wire is pivotably and removably connected to a second of the lower and upper trays by means of a hook removably or non-removably fixed to the second tray, the hook being positioned in such a way that it produces an offset between the first and second trays in at least a direction perpendicular to the axis of pivoting of the spring wire with respect to the second tray.

### CROSS REFERENCE TO RELATED APPLICATIONS

This patent application claims priority to European Patent Application No. 14152944.6 filed Jan. 28, 2014, the contents of which are incorporated herein by reference in their entirety.

### TECHNICAL FIELD

The subject of the present invention is a dental appliance for adjusting the position of the lower jaw of a patient with respect to the upper jaw thereof.

### BACKGROUND

Dental appliances for adjusting the position of the lower jaw are used, on the one hand, in orthodontics and, on the other hand, to prevent snoring and obstructive sleep apnoea.

It is known in particular that the pathological manifestations of sleep such as snoring or sleep apnoea may be prevented by keeping the lower jaw in a forward position in relation to the upper jaw. Numerous appliances capable of keeping the jaws in this condition have already been proposed, but most exhibit defects which hamper their widespread application.

Thus, US Publication No. US 2011/0277774 discloses an oral appliance intended to prevent snoring and comprising two parts each with a dental tray suited to one of the jaws, the upper and lower jaw respectively, the trays being connected to one another by means of a metal wire intended to be partially housed inside corresponding fixing members of the trays. In this known appliance, one of the fixing members is an upper hollow tube which is embedded in the dental tray covering the upper jaw and in which the metal wire is partially housed, the upper tube being positioned at the front of the mouth. The other two fixing members consist of two lower hollow tubes which are partially embedded in the dental tray covering the lower jaw and in which the ends of the metal wire are housed, the lower tubes being positioned at the back of the mouth. This appliance does, however, have a number of disadvantages. First, because the lower tubes are positioned in the vestibular part of the mouth, the patient finds them very bothersome. Moreover, the fact that the fixing members of the lower jaw are tubes oriented towards the front of the mouth considerably limits the possibility of opening the mouth. Neither does this appliance allow the dental trays any lateral movement relative to one another, In addition, the fact that both ends of the wire are locked means that the wire is subjected almost permanently to torsion forces which, with use, may lead to dangerous breakages of the metal wire in the vestibular regions of the mouth and to unwanted disengagement of the dental trays. Finally, this appliance does not allow the separation between the lower tray and the upper tray to be adapted in a way that is reliable and comfortable for the patient.

### SUMMARY

It is therefore an object of the present invention to propose a dental appliance which does not have the disadvantages of the abovementioned prior art.

To this end, the appliance according to the invention is characterized in that it comprises an upper tray and a lower tray which are intended respectively to fit the teeth of the upper jaw and of the lower jaw, in which the trays are connected to one another by means of a spring wire having substantially the shape of a U, the spring wire being arranged in an occlusal position between the trays without protruding into the vestibular regions of the mouth of the patient, in which each of the ends of the spring wire is mounted pivotably on a first of the trays, lower or upper, about an axis of pivoting parallel to the occlusal plane of contact of the teeth of the lower and upper jaws, in which the spring wire is pivotably and removably connected to a second of the trays, lower or upper, by means of a hook fixed removably or non-removably to the second tray, the hook being positioned in such a way that it produces an offset between the first and second trays in at least a direction perpendicular to the axis of pivoting of the spring wire with respect to the second tray.

Other alternative forms of the invention are defined in dependent claims 2 to 20.

Configured in this way, the appliance of the invention does not clutter the vestibular part of the mouth. Furthermore, it allows the patient a certain opening of the mouth while limiting the forces applied to the spring wire that connects the lower and upper trays. Finally, it allows the relative position between the lower tray and the upper tray to be varied to suit the dental morphology of the patient.

### BRIEF DESCRIPTION OF THE DRAWINGS

One embodiment of the appliance according to the invention, and a number of alternative forms thereof, are described hereinafter simply by way of nonlimiting examples with reference to the attached drawings in which:

FIGS. 1 and 2 are, respectively, a side view and a perspective view of a first embodiment of the appliance according to the invention in its normal position of use,

FIG. 3 is a perspective view of the assembly comprising a lower tray and a spring wire of the appliance depicted in FIGS. 1 and 2,

FIG. 4 is a view from above of the spring wire of the appliance depicted in FIGS. 1 and 2,

FIG. 5 is a perspective view of a second embodiment of the appliance according to the invention in its normal position of use,

FIG. 6 is a perspective view of the lower tray of the appliance depicted in FIG. 5, and

FIGS. 7a to 7e are enlarged views of the hook used in the appliance depicted in FIG. 5 as it is progressively fitted to a corresponding fixing element of the lower tray.

### DETAILED DESCRIPTION OF EXEMPLARY EMBODIMENTS

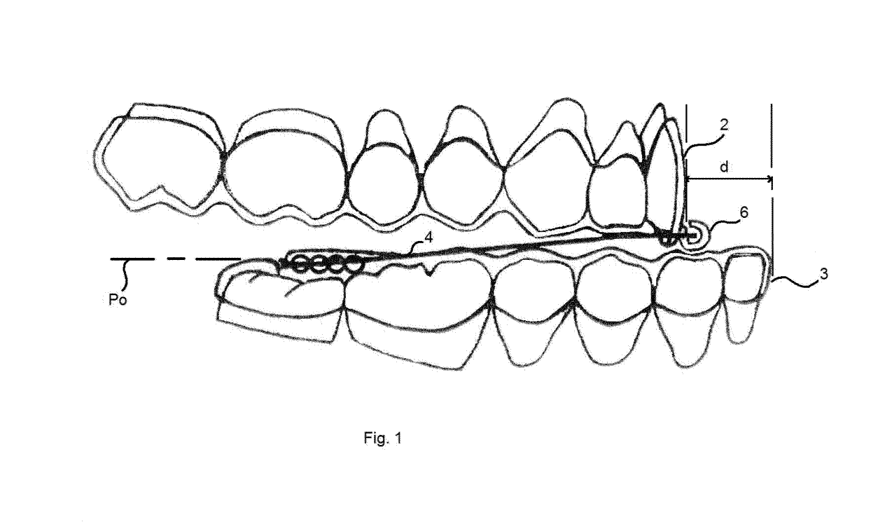

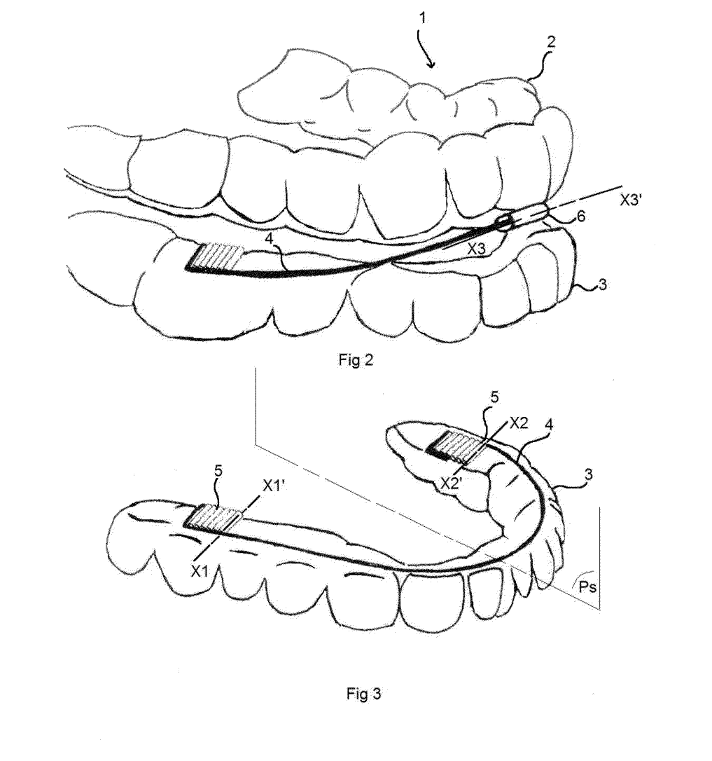

With reference to FIGS. 1 and 2 it may be seen that the dental appliance 1 fitted in the mouth of a patient comprises an upper tray 2 and a lower tray 3 which are connected by means of a spring wire 4. Each of the trays 2, 3 reproduces, in the form of an impression, the shape of the teeth of the upper and lower jaws respectively. The trays 2, 3 are produced by thermoforming to suit the morphological features of the jaws of the patient so as to be a perfect fit thereto. The materials of which the trays 2, 3 are made are preferably synthetic acrylic resin or biocompatible thermoformed sheets.

As depicted in FIGS. 3 and 4, the spring wire 4 is substantially in the shape of a U and is arranged in an occlusal position between the trays 2, 3 without protruding into the vestibular part of the mouth of the patient. This spring wire 4 may advantageously be made of a metal that has a good capacity for elastic deformation, particularly a nickel-titanium alloy. This spring wire 4 may thus be able to experience torsion such that its ends move away from or closer to the position of equilibrium depicted in FIG. 4, thus allowing the spring wire 4 to be fixed removably to the lower tray 3. This fixing may be performed in a number of different ways. In the version depicted, this fixing is achieved using a series of tubular housings 5 formed inside the lower tray 3, the tubular housings 5 being able to accept an end segment 4c of each of the branches of the spring wire 4. It will thus be advantageous to use tubular housings, the internal diameter of which is slightly greater than the diameter of the spring wire 4, which will be comprised between 0.5 and 1.5 mm. Such tubular housings 5 may advantageously be formed by means of hollow tubes embedded inside the lower tray 3. For preference, the tubular housings 5 will be positioned level with the first and second lower molars and symmetrically about a plane of symmetry Ps of the lower tray 3. They will advantageously be perpendicular or substantially perpendicular to this plane of symmetry Ps. Thus positioned, the tubular housings 5 will define two axes of pivoting X1-X1′ and X2-X2′ about which the spring wire 4 can pivot once the end segments 4c have been introduced into one of the tubular housings 5. The axes of pivoting X1-X1′ and X2-X2′ will advantageously be parallel to the occlusal plane Po of contact of the teeth of the lower and upper jaws. Depending on the desired degree of forwardness or protrusion, the patient will thus be able to choose to introduce the end segments 4c into a tubular housing 5 that is a greater or lesser distance away from the frontal part of the lower tray 3, which will be in contact with the lower lips of the mouth at the level of the lower incisors. As explained in detail hereinafter, this choice will make it possible to vary the offset between the upper tray 2 and the lower tray 3 in a direction parallel to the plane Ps. It should be pointed out here and now that the choosing of the most suitable tubular housing and the fixing of the spring wire into this tubular housing can be performed by the patient himself, without the need to resort to a professional practitioner and without the use of a special tool. This therefore constitutes an additional advantage that the dental appliance of the present invention exhibits over the dental appliances of the prior art.

In another possible configuration (not depicted) of the invention, the ends of the spring wire 4 may be secured to the lower tray 3, notably by embedding the ends 4c in the lower tray 3. However, because of the elasticity of the spring wire 4, it will still be possible to make the spring wire 4 pivot about the axes X1-X1′ and X2-X2′.

As depicted in FIGS. 1 and 2, the middle part 4d of the spring wire 4, corresponding substantially to that part of the spring wire 4 through which the plane Ps crosses, is intended to be housed inside a hook 6 secured to the upper tray 2. The hook 6 will advantageously be positioned level with the upper central incisors and, for preference, fixed in the continuation of the lower face of the upper tray 2 which faces the upper face of the lower tray 3, the hook 6 protruding slightly beyond the frontal edge of the upper tray 2, in this position, it generates an offset d between the upper tray 2 and the lower tray 3, because the middle part 4d of the spring wire 4, which is housed inside of the hook 6, is positioned set back from the frontal edge of the lower tray 3. This offset d will be all the greater if the end segments 4c of the spring wire are introduced into the tubular housings 5 furthest away from the frontal edge. As depicted in FIG. 2, the hook 6 may notably possess a semi-tubular part centered around an axis X3-X3′ perpendicular to the plane of symmetry of the upper tray 2. In the alternative form depicted, this plane of symmetry coincides with the plane of symmetry Ps of the lower tray 3. Thus configured, it will be possible to make the upper tray 2 pivot about the axis X3-X3′ while at the same time allowing the hook 6 a sliding movement along the spring wire 4. These additional possibilities of relative movement between the upper and lower trays appreciably improve user comfort so far as the patient is concerned.

Moreover, in order to prevent the patient from accidentally disconnecting the upper and lower trays while sleeping, notably by opening his mouth too far, the spring wire 4 will advantageously be configured to limit the amplitude of the relative pivoting between the upper tray 2 and the lower tray 3. For that purpose and as depicted in FIG. 4, each of the ends of the spring wire 4 will possess at least three successive segments, namely:
a first segment 4a parallel to the axis of pivoting X1-X1′ or X2-X2′,
a second segment 4b contiguous with and perpendicular to the first segment 4a, and
a third segment 4c contiguous with and perpendicular to the second segment 4b,
   with the first, second and third segments 4a, 4b and 4c being aligned in a plane which is parallel to the occlusal plane Po or slightly inclined with respect to the occlusal plane Po, the angle of inclination being less than 5°. As mentioned previously, the third segment 4c of each of the ends of the spring wire 4 is intended to be introduced into one of the tubular housings 5 which are formed on the inside of the lower tray 3, thus allowing the spring wire 4 to pivot about the axes X1-X1′ and X2-X2′, However, as the spring wire 4 gradually pivots about the axes X1-X1′ and X2-X2′, the second segment 4b moves closer to the lower tray 3 until it comes into abutment against the upper surface of the lower tray 3 in a limiting position of the spring wire 4 that corresponds to the maximum amplitude of opening of the mouth of the patient. Thus configured, the spring wire 4 allows the mouth to be opened sufficiently while at the same time limiting the risks of the lower and upper trays becoming disconnected.

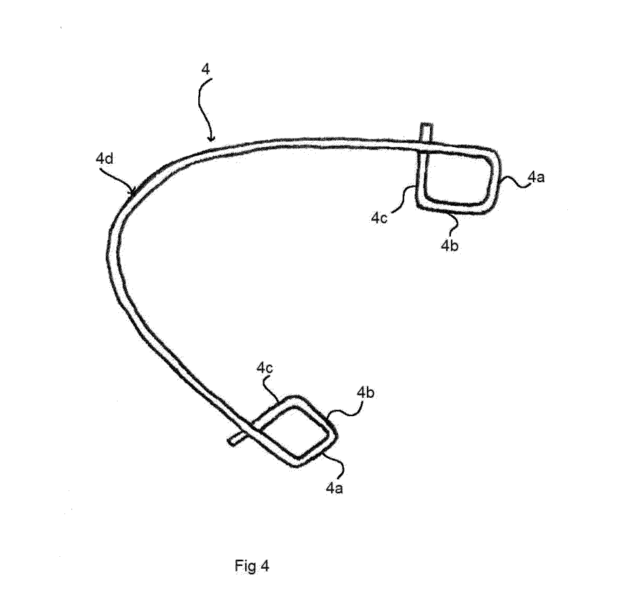

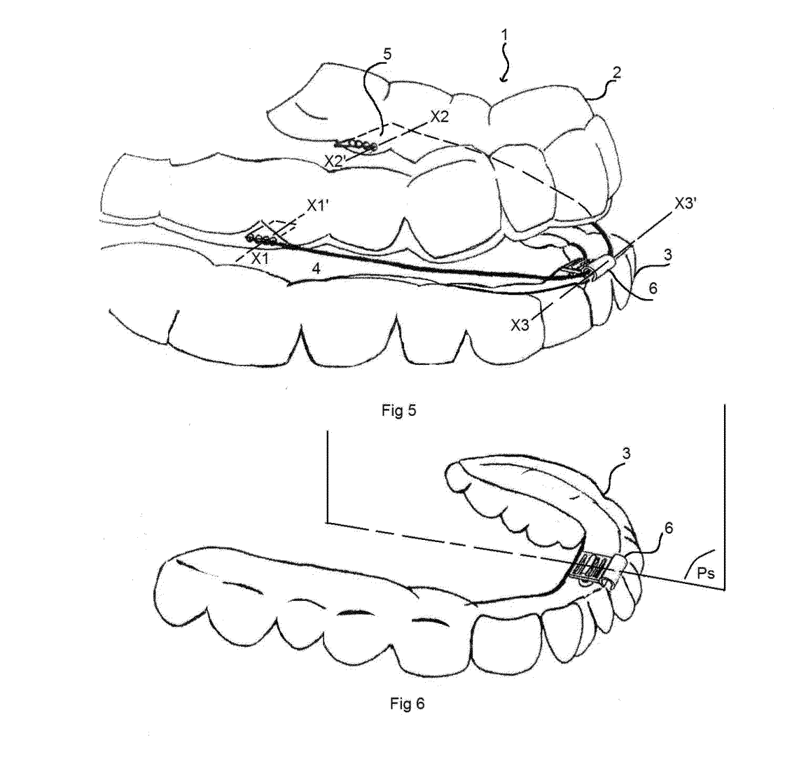

FIGS. 5 and 6 depict one possible alternative form of embodiment of the dental appliance of the present invention.

In this alternative form, the tubular housings 5 are formed inside the upper tray 2 and the hook 6 is fixed removably to the lower tray 3. Thus, in its position of use, the spring wire 4 butts against the internal walls of the semi-tubular part of the hook 6. Unlike in the previous form of embodiment, in which the spring wire 4 was subjected to a tensile force, in the present alternative form the spring wire 4 is subjected to a compressive force, Because of this compressive force, the spring wire 4 will have a tendency to deform in such a way that its branches diverge towards the vestibular regions of the mouth, This alternative form may therefore, in certain cases, prove less comfortable in use than the first alternative form. Advantageously, the hook 6 is fixed to the lower tray 3 in such a way that its position in a direction parallel to the plane of symmetry Ps, as defined previously, is variable. Thus, the user will be able to move the hook 6 forward or back, thus offering the patient additional possibilities to vary the relative positions of the upper and lower trays 2 and 3. It is obvious that such additional possibilities may also be envisaged in the first alternative form of embodiment depicted in FIGS. 1 and 2 and in another alternative form of embodiment (which has not been depicted), in which the ends of the spring wire 4 are secured to the upper tray 2, in instances in which the hook 6 is fixed removably to the lower tray 3, or secured to the lower tray 3, in instances in which the hook 6 is fixed removably to the upper tray 2.

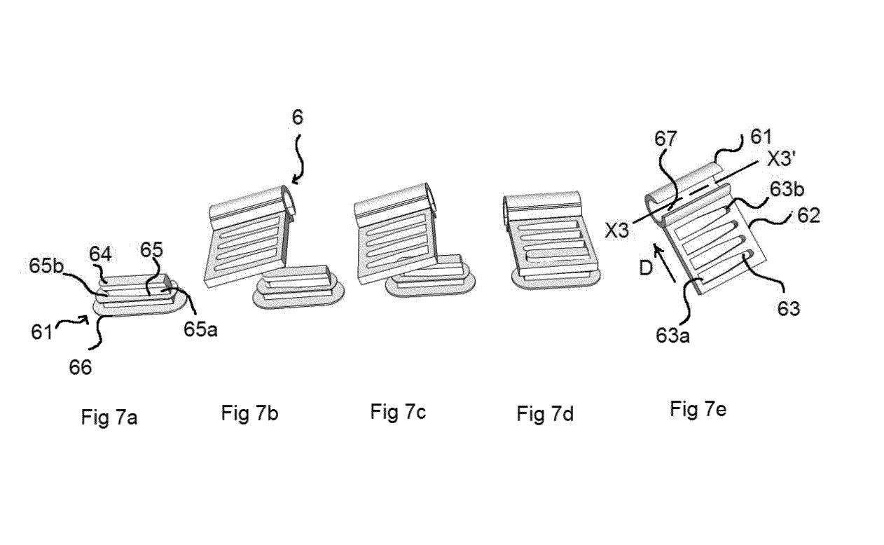

Removable fixing of the hook 6 to the upper tray 2 or to the lower tray 3 may be performed in a number of different ways. In the alternative form depicted in FIGS. 5 and 6, and as illustrated in detail in FIGS. 7a to 7e, the hook 6 is formed of a semi-tubular part 61 defining an axial opening 67 secured to a substantially rectangular plate 62, the plate 62 being pierced with a number of openings 63 which are evenly spaced in a longitudinal direction D perpendicular to the axis X3-X3′ defined by the part 61. As depicted in FIG. 7e, the openings 63 have substantially the same shape, the shape being defined by a wide end 63a and by a narrow end 63b. The openings 63 are in particular configured to accept a middle part 65 of a fixing element 6′ which is secured to one of the trays 2, 3 of the dental appliance of the invention. Advantageously, the middle part 65 has a shape substantially corresponding to the shape of the openings 63 so that it is defined by a wide end 65a and by a narrow end 65b. The element 6′ also comprises a lower part 66 intended to be embedded inside the tray, and an upper part 64 intended to cap the middle part 65 in such a way that it protrudes on each side of its narrow end 65b. Thus, as depicted in FIGS. 7b, 7c and 7d, the hook 6 will be fixed on the fixing element 6 by aligning the upper part 64 of the fixing element 6′ with one of the openings 63 (see FIG. 7b), by causing the upper part 64 to pass partially through the opening 63 at the wide end 63a (see FIG. 7c), by moving the plate 62 of the hook 6 parallel to the axis X3-X3′ until the narrow end 65b of the middle part 65 comes into abutment against the narrow end 63b of the opening 63 (see FIG. 7d) and finally by pivoting the plate 62 until the upper part 64 has passed completely through the opening 63 and become positioned on top of the plate 62, in the case where the opening 67 is facing downwards, as illustrated in FIG. 6, or is positioned underneath the plate 62, in the case where the opening 67 faces upwards.

It goes without saying that the invention is not restricted to the forms of embodiment described hereinabove by way of example but that on the contrary it encompasses all alternative forms of embodiment thereof.

1. A dental appliance for adjusting the positioning of the lower jaw of a patient with respect to the upper jaw thereof, the dental appliance comprising:
an upper tray and a lower tray which are intended respectively to fit the teeth of the upper jaw and of the lower jaw,
wherein the trays are connected to one another by means of a spring wire being substantially U-shaped, the spring wire being arranged in an occlusal position between the lower and upper trays without protruding into a vestibular regions of the mouth of the patient,
wherein each end of the spring wire is mounted pivotably on a first of the upper and lower trays about an axis of pivoting arranged parallel to the occlusal plane of contact of the teeth of the lower and upper jaws, and
wherein the spring wire is pivotably and removably connected to a second of the lower or upper trays by means of a hook removably or non-removably fixed to the second tray, the hook being positioned such that the hook produces an offset between the first and second trays in at least a direction perpendicular to the axis of pivoting of the spring wire with respect to the second tray.

2. The dental appliance according to claim 1, wherein each end of the spring wire is removably mounted on the first tray.

3. The dental appliance according to claim 2, wherein the first tray has several pairs of tubular housings, each of the pairs of tubular housings being able to accept the ends of the spring wire, the pairs thus making it possible to vary the position of the axes of pivoting of each end of the spring wire to vary the offset between the first tray and the second tray.

4. The dental appliance according to claim 1, wherein each end of the spring wire is shaped to define a limit stop limiting pivoting of the spring wire with respect to the first tray.

5. The dental appliance according to claim 4, wherein each end of the spring wire has at least three successive segments including:
a first segment arranged parallel to the axis of pivoting of one of the ends,
a second segment contiguous with and arranged perpendicular to the first segment, and
a third segment contiguous with and arranged perpendicular to the second segment, the first, second and third segments being aligned in a plane arranged parallel to the occlusal plane of contact of the teeth of the lower and upper jaws or slightly inclined at an angle inclination with respect to the occlusal plane, the angle of inclination being less than 5°, in that at least one pair of tubular housings formed inside the first tray is able to accept the third segments of the ends, the tubular housings thus defining the axes of pivoting of the ends, and in that the spring wire is able to pivot about the axes of pivoting until the second segments of the ends come into abutment against the first tray.

6. The dental appliance according to claim 5, wherein the first tray possesses several pairs of tubular housings, each of the pairs being able to accept the third segments of the ends of the spring wire, the pairs thus allowing the position of the axes of pivoting of each of the ends to be varied and, thereby, allowing the offset between the first tray and the second tray to be varied.

7. The dental appliance according to claim 3, wherein the tubular housings are formed of hollow tubes embedded inside the first tray.

8. The dental appliance according to claim 1, wherein the first tray and/or the second tray possesses a plane of symmetry.

9. The dental appliance according to claim 8, wherein the axes of pivoting of the ends of the spring wire are perpendicular or substantially perpendicular to the plane of symmetry of the first tray.

10. The dental appliance according to claim 8, wherein the hook possesses a semi-tubular part centered around an axis perpendicular to the plane of symmetry of the second tray, the semi-tubular part defining a slot and being able to at least partially house the spring wire.

11. The dental appliance according to claim 1, wherein each of the ends of the spring wire is secured to the first tray.

12. The dental appliance according to claim 1, wherein the hook is secured to the second tray.

13. The dental appliance according to claim 1, wherein the hook is fixed removably to the second tray.

14. The dental appliance according to claim 13, wherein the hook possesses a semi-tubular first part and a second part of planar shape, the semi-tubular part being able to at least partially house the spring wire and the second part being able to at least partially house a fixing element of the second tray.

15. The dental appliance according to claim 14, wherein the fixing element possesses a middle part able to be housed inside an opening formed inside the planar part of the hook, the middle part and the opening possessing substantially the same shape.

16. The dental appliance according to claim 15, wherein the planar part of the hook is pierced with a plurality of openings of identical shape, evenly spaced in a direction perpendicular to the axial direction defined by the semi-tubular part of the hook.
